(19) United States
(12) Patent Application Publication
(10) Pub. No.: US 2026/0078278 A1
(43) Pub. Date: Mar. 19, 2026

(54) HIGH TEMPERATURE SURFACING FILM FOR COMPOSITE SUBSTRATES

(71) Applicant: Cytec Industries Inc., Lawrence, NJ (US)

(72) Inventors: Jessica L. WALLICK, Alpharetta, GA (US); Junjie Jeffrey SANG, Newark, DE (US); Dalip K. KOHLI, Churchville, MD (US)

(21) Appl. No.: 19/102,729

(22) PCT Filed: Aug. 10, 2023
(86) PCT No.: PCT/US2023/071995

§ 371 Date: Feb. 10, 2025

Related U.S. Application Data
(60) Provisional application No. 63/397,710, filed on Aug. 12, 2022.

(51) Int. Cl. C09D 179/08; C08J 5/04; C08J 5/24

(52) U.S. Cl. CPC C09D 179/085; C08J 5/0405; C08J 5/241; C08J 2379/08; C08J 2463/00

(57) ABSTRACT

A high-temperature surfacing film formed from a curable resin composition containing: (i) at least one bismaleimide (BMI) monomer: (ii) at least one co-monomer that is reactive with the BMI monomer: (iii) a pre-react adduct that enhances film-forming properties and improves toughness: (iv) inorganic microspheres; and (v) a flow control agent in the form of particulate inorganic fillers that are not microspheres.

### DETAILED DESCRIPTION

Fiber-reinforced, polymer matrix composite (PMC) is a high-performance structural material that is commonly used in applications requiring resistance to aggressive environments, high strength, and/or low weight. Examples of such applications include aircraft components (e.g., tails, wings, fuselages, and propellers), high performance automobiles, boat hulls, and bicycle frames. Composite structural parts for aerospace applications typically include a surfacing film to provide the required performance characteristics to the composite structures prior to painting. Such surfacing film is used to improve the surface quality of the structural parts while reducing labor, time and cost. Surfacing films are usually co-cured with the PMC materials during the manufacturing of the structural parts. Such surfacing films are also commonly combined with lightning strike protection (LSP) materials to provide a surfacing and LSP all-in-one solution.

Currently, the majority of surfacing films for aerospace applications are formed from epoxy-based resin compositions, which contain epoxy resins as the thermoset resin component. Such epoxy-based surfacing films may be co-cured with epoxy-based composite substrates at a temperature within the range of 121° C.-176° C. (or 250° F.-350° F.). The resulting epoxy-based surfacing film usually have a glass transition temperature (T_{g}) of approximately 350° F. (˜176° C.) or lower. After co-curing, the resulting cured surfacing films eliminate surface imperfections such as pinholes and pits on the composite substrates.

Surfacing materials for aerospace applications usually include epoxy resins because they yield good mechanical properties, enable wide service temperature range, and allow easy application during part manufacturing. The maximum service temperature is defined as the highest temperature at which the material can be used, for prolonged periods, without significant change in the properties or decomposition. Epoxy-based surfacing materials cannot be used in extreme environments such as high temperature applications above about 180° C. Consequently, their maximum service temperature is about 180° C. and cannot be utilized for higher temperature applications, which are common in aerospace applications.

Where aerospace applications require service temperatures beyond the capability of epoxy resins, bismaleimide (BMI) resins have been used. Current BMI-based composites can be used at service temperatures in the range of 149° C. to 265° C. and can provide excellent mechanical properties such as resistance to micro-cracking at such service temperature for prolong periods. BMI resins can be cured initially at relatively low temperatures (e.g., 350° F. or 176° C.) and then post-cured at high temperatures (e.g., 450° F.-510° F. or 232° C.-265° C.) to complete the polymerization reactions and to yield highly cross-linked networks with high glass transition temperatures. There remains a need to have a surfacing material that can be co-curable with BMI-based composites. Such surfacing material must be able to withstand the post-cure conditions of BMI resins.

Disclosed herein is a surfacing film for PMC that can be used at high service temperatures above 176° C., and furthermore, can be co-cured with high-temperature thermoset composite materials such as BMI-based composite materials. This surfacing film is referred herein as “HT surfacing film”.

The HT surfacing film is formed from a curable resin composition containing: (i) at least one bismaleimide (BMI) monomer; (ii) at least one co-monomer that is reactive with the BMI monomer; (iii) a pre-react adduct that enhances film-forming properties and improves toughness; (iv) inorganic microspheres or micro-balloons to improve the surface smoothness of the film; and (v) a flow control agent in the form of particulate inorganic fillers that are not microspheres or micro-balloons. The curable resin composition may further contain pigments or dyes to add color to the HT surfacing film.

The combination of BMI monomer(s) and co-monomer(s) constitutes, in weight percentage, more than 45%, in some embodiments, more than 50%, of the total weight of the curable resin composition. In a preferred embodiment, the curable resin composition does not contain any epoxy resin other than that used for the formation of the pre-react adduct.

Upon curing, the cured HT surfacing film has a glass transition temperature (T_{g}) of greater than 176° C., for example, 270° C.-300° C. (or 518° F.-572° F.). The cured HT surfacing film can be used at a service temperature of greater than 176° C. (or >350° F.), for example, 200° C. (392° F.) to 265° C. (510° F.).

The terms “cure” and “curing” as used herein refer to the irreversible hardening of a pre-polymer material or a resin precursor brought about by heating at elevated temperatures, exposure to ultraviolet light and radiation, or chemical additives. The term “curable” means can be cured into a hardened material.

### Bismaleimides (BMI)

BMI monomers are generally prepared by the reaction of maleic anhydride, or substituted maleic anhydrides, with a suitable diamine. Both aromatic and aliphatic diamines are suitable for preparation of the BMI. The curable resin composition of the HT surfacing film may comprise both aromatic and aliphatic BMI monomers.

Eutectic mixtures of two or more different bismaleimide monomers may be used. Through the use of such mixtures, the melting point of the bismaleimide component is considerably depressed relative to the melting point of individual bismaleimide monomers.

Suitable BMI monomers include, but are not limited to: 4,4-bismaleimido-diphenylmethane (BMI-H); 2,2-bismaleimidotoluene m-xylylene bismaleimide (MXBI); p-xylylene bismaleimide; 1,6-hexamethylenediamine bismaleimide (HMDA-BMI); 1,2-bis(maleimido) ethane; 1,4-di(maleimido) butane; 2,2-Bis [4-(4-maleimidophenoxy)-phenyl]propane; N,N′-(1,3-phenylene)dimaleimide; N,N′-(1,4-Phenylene)dimaleimide; 4,4-bismaleimidodiphenyl ether; bis-maleimidomethyl ether; bis(4-maleimidophenyl) sulfone; N,N′-4,4′-3,3′-dichloro-diphenylmethane-bismaleimide; N-phenylmaleimide.

### Co-Monomers

Bismaleimide monomers are reacted with co-monomers to improve processability, impart toughness and create highly crosslinked networks. Suitable co-monomers are selected from allyl compounds, aromatic amines, and propenyl benzophenone (or propenylphenol ether compound).

Suitable allyl compounds are characterized by the presence of two or more allyl or methallyl groups per aromatic nucleus. Preferred allyl compounds include: 2,2′-Diallyl Bisphenol A or o,o′-Diallyl Bisphenol A (commercially available as Matrimid® 5292B from Huntsman, and Compimide® TM124 from Evonik Corp.); Diallyl Ether of Bisphenol A; 2,2′-Diallyl-4,4′-biphenol; 3′-Allyl-4′hydroxyacetophenone; Diallyl Phthalate; Triallyl Isocyanurate; Triallyl Cyanurate; and Triallyl Trimellitate.

Preferred aromatic amines include: 4,4′-methylenedianiline (MDA); 4,4′-Diaminodiphenyl-sulfone (DDS); m- or p-phenylene diamine (PD).

Propenyl benzophenone (or propenylphenol ether compound) is in liquid form at room temperature and is characterized by two or more propenyl phenoxy groups per aromatic nucleus. An example of a suitable propenyl benzophenone is 4,4′-bis(o-propenyl-phenoxy)benzophenone (commercially available as Compimide® TM123 from Evonik Corp.), which reacts with BMI to form a tough and temperature-resistant polymer network.

### Pre-React Adduct

One drawback of BMI resin is its brittleness. The presence of the pre-react adduct improves the film-forming property of the BMI-based curable composition and the flexibility (or draping ability) of the BMI-based film. The presence of the pre-react adduct also improves the toughness and micro-cracking resistance of the cured BMI polymer.

In one embodiment, the pre-react adduct is a reaction product of a difunctional epoxy resin, epoxy dicyclopenta-diene (DCPD), and an elastomer. In another embodiment, the pre-react adduct is a reaction product of core-shell rubber (CSR) particles, one or more multifunctional epoxy resins, epoxy dicyclopenta-diene (DCPD), and an elastomer. The multifunctional epoxy resins include di-functional, tri-functional and tetra-functional epoxy resins. The reaction is preferably carried out in the presence of an accelerator, for example, triphenyl phosphine.

Multifunctional epoxy resin refers to a polyepoxide with two or more epoxy functional groups per molecule. Difunctional epoxy resin refers to a polyepoxide with two epoxy functional groups per molecule, tri-functional epoxy resin refers to a polyepoxide with three epoxy functional groups per molecule, and tetra-functional epoxy resin refers to a polyepoxide with four epoxy functional groups per molecule.

Suitable difunctional epoxy resins for forming the pre-react adduct include digylcidyl ethers of bisphenol A (e.g. Epon™ 828 (liquid epoxy resin) from Hexion, DER 331, D.E.R. 661 (solid epoxy resin) supplied by Dow Chemical Co., Tactix 123, and Araldite® 184 supplied by Huntsman Advanced Materials). Additional difuctional epoxy resins for forming the pre-react adduct can include diglycidylethers of Bisphenol F, diglycidylethers of Bisphenol S, diglycidylethers of Bisphenol Z, diglycidylethers of tetrabromo bisphenol A, and the diepoxide of hydrogenated Bisphenol A.

Suitable tri-functional epoxy resins for forming the pre-react adduct include triglycidyl ether of aminophenol. Specific examples of commercially available tri-functional epoxy resins are Araldite® MY 0510, MY 0500, MY 0600, MY 0610 supplied by Huntsman Advanced Materials.

A suitable tetra-functional aromatic epoxy resin is a polyepoxide with at least one glycidyl amine group. An example is tetraglycidyl ether of methylene dianiline having the following general chemical structure:

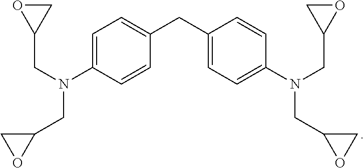 [SMILES: c1cc(N(CC2CO2)CC2CO2)ccc1Cc1ccc(N(CC2CO2)CC2CO2)cc1]

The amine groups in structure are shown in the para- or 4,4′ positions of the aromatic ring structures, however, it should be understood that other isomers, such as 2,1′, 2,3′, 2,4′, 3,3′, 3,4′, are possible alternatives. Examples of commercially available tetra-functional epoxy resins are Araldite® MY 9663, MY 9634, MY 9655, MY-721, MY-720, MY-725 supplied by Huntsman Advanced Materials.

The epoxy dicyclopenta-diene (DCPD) is a dicyclopentadiene based epoxy resin and a multi-functional hydrocarbon epoxy novolac, having the chemical formula/structure:

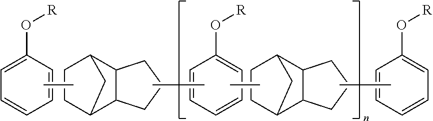

where

### R=

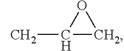

n=1 to 3.

CSR particles for forming the pre-react adduct may have particle size of 300 nm or less. Particle size can be measured by a laser diffraction technique, for example, using a Malvern Mastersizer 2000 instrument. The CSR particles may be any of the core-shell particles where a soft core is surrounded by a hard shell. Preferred CSR particles are those having a polybutadiene rubber core or butadiene-acrylonitrile rubber core and a polyacrylate shell. CSR particles having a hard core surrounded by a soft shell may also be used, however. The CSR particles may be supplied as a suspension containing 25%-40% in weight percentage of CSR particles dispersed in a liquid epoxy resin, for example, Kane Ace™ MX 120, MX 125, or MX 156 (containing 25%-37% by weight of CSR particles in D.E.R.™ 331 epoxy resin) available from Kaneka.

The elastomer for forming the pre-react adduct is preferably an elastomeric polymer having carboxyl or amine functional groups. Suitable elastomers for forming the pre-react adduct include, but are not limited to, rubbers such as, for example, amine-terminated butadiene acrylonitrile (ATBN), carboxyl-terminated butadiene acrylonitrile (CTBN), carboxyl-terminated butadiene (CTB), fluorocarbon elastomers, silicone elastomers, styrene-butadiene polymers. In an embodiment, the elastomer used for forming the pre-react adduct is CTBN or CTB.

In one embodiment, the pre-react adduct is formed by reacting a difunctional epoxy resin and epoxy dicyclopentadiene (DCPD) with an elastomer polymer (preferably, having carboxyl or amine groups) in the presence of a catalyst, such as triphenyl phosphine (TPP), at about 300° F. (or 148.9° C.) to chain link the epoxy resin and elastomer and to form a high viscosity, film-forming, high molecular-weight, epoxy-based pre-react adduct. The pre-react adduct is then mixed with the remaining components of the curable composition for forming the HT surfacing film.

In another embodiment, the pre-react adduct is formed by reacting a suspension of CSR particles in a liquid difunctional epoxy resin with DCPD, an elastomer, and optionally, a tri-functional or tetra-functional epoxy resin, in the presence of a catalyst as described above. The presence of the CSR particles provides additional toughness to the cured surfacing film. Such enhanced toughness is advantageous when working with the BMI resins that are inherently brittle. The presence of the tri-functional or tetra-functional epoxy resin increases the strength of the cured surfacing film and further raises its T_{g}.

The amount of pre-react adduct in the curable composition is approximately 8%-30% by weight based on the total weight of the curable composition.

### Inorganic Microspheres

Microspheres or micro-balloons are added to the curable composition to improve the surface smoothness of the surfacing film. Such microspheres are small, spherical, hollow bodies. Each microsphere has an outer shell enclosing a hollow core. The inorganic microspheres may be made from various materials, including glass, silica (SiO₂), and ceramic. Microspheres having diameters ranging from about 0.1 μm to about 20 μm, and preferably from about 1 μm to about 15 μm, have been found to be particularly suitable.

In a preferred embodiment, the inorganic microspheres are hollow, ceramic microspheres, for example, microspheres made of an inert silica-alumina ceramic material. The ceramic microspheres may have a crush strength of over 60,000 psi, a dielectric constant of about 3.7-4.6, a softening point in the range of 1000-1100° C. (or 1832-2012° F.), and particle diameters ranging from 0.1 micron to 50 microns, or 1 to 50 microns. The high softening point of the ceramic microspheres enables them to be nonabsorbent to solvents, non-flammable, and highly resistant to chemicals. An example of commercially available ceramic microspheres which are particularly suitable for use in the surfacing film composition are sold by Zeelan Industries, Inc. under the trade name Zeeospheres®, for example, G-200, G210 and W-200. These are hollow, silica-alumina spheres with thick walls, odorless, and light gray in color.

The amount of inorganic microspheres is at least 3% by weight, based on the total weight of the curable composition. For example, the amount of ceramic microspheres, in weight percentages, may be within the range of about 5% to about 15%, or about 10% to about 30%, or about 20% to about 40%, by weight based on the total weight of the curable composition.

### Flow Control Agents

Inorganic fillers in the form of particles, which are different from the inorganic microspheres or micro-balloons, may be added to the curable composition as a flow control agent or a rheology modifying component to control the flow of the resinous composition and to prevent agglomeration of the components therein. The filler particles include powder and particles of any shape. Suitable inorganic fillers that may be used in the curable composition include talc, mica, calcium carbonate, alumina, and silica. In one embodiment, hydrophobic fumed silica (e.g. Cab-O-Sil TS-720) is used as the inorganic filler. The amount of flow control agent may be within the range from about 0.5% to about 5% by weight based on the total weight of the curable resin composition.

### Optional Additives

Pigments and/or dyes known in the art for adding color to resinous systems may be added to the curable composition. Examples of pigments and/or dyes include, but are not limited to, red iron oxide, green chromium, carbon black, and titanium oxide. In an embodiment, titanium oxide (white) pigment is added to the resin composition. In another embodiment, carbon black pigment is added. Such pigments/dyes may be added in an amount of 0.5 to 10% by weight based on the total weight of the curable composition.

### EXEMPLARY EMBODIMENTS

Some embodiments of the curable composition for forming the HT surfacing film of the present disclosure are shown below.

| | Embodiments | | |
|---|---|---|---|
| | 1 | 2 | 3 |
| Components | wt % | wt % | wt % |
| Pre-react adduct | 8-30 | 8-30 | 8-30 |
| Bismaleimide Monomer | 30-45 | 25-35 | 20-30 |
| Bismaleimide Co-monomer | 20-30 | 25-40 | 20-30 |
| Ceramic Microspheres or Glass Balloons | 10-20 | 15-20 | 20-30 |
| Fumed Silica (flow control agent) | 1-5 | 1-10 | 1-5 |

The amounts in the above embodiments are in weight percentage (wt %) based on the total weight of the entire composition.

In one embodiment, the pre-react is formed by reacting the following components, in weight percentages (wt %):
1-5 wt % Carboxylated Nitrile elastomer;
1-5 wt % CTBN or CTB elastomer;
1-15 wt % Epoxy Dicyclopentadiene (DCPD);
5-15 wt % Diglycidyl Ether of Bisphenol A;
1-2 wt % Accelerator (preferably, Triphenyl Phosphine).

In another embodiment, the pre-react is formed by reacting the following components, in weight percentages (wt %):
1-5 wt % Carboxylated Nitrile elastomer;
5-15 wt % liquid difunctional epoxy resin containing 25-40 wt % CSR particles (e.g. MX 120, MX 156);
1-15 wt % Epoxy Dicyclopentadiene (DCPD);
1-15 wt % tri-functional epoxy resin (e.g., MY510) or tetra-functional epoxy resin (e.g., MY 721, MY 9663);
1-2 wt % Accelerator (preferably, Triphenyl Phosphine).

### Manufacturing Methods and Applications

To form a surfacing film, the components of the curable composition are added to a mixing vessel and blended at room temperature (23° C.-25° C.) using a solution process. One or more organic solvents may be added to facilitate mixing of the components and film formation. Possible solvents include methyl ethyl ketone (MEK), acetone, N-methylpyrrolidone (NMP), ethanol, dioxalane, and propylene carbonate. A surfacing film is subsequently formed from the curable composition using conventional film-forming processes. The resulting surfacing film may have an aerial weight of 0.01 to 0.045 psf (or 48 gsm to 220 gsm) depending on the intended use.

To facilitate the handling of the surfacing film, a carrier can be imbedded into the film. The carrier may be selected from a fibrous sheet made of thermoplastic polymer fibers or carbon fibers, a metallic screen or foil, non-woven mat, random mat, knit carrier, metal coated carbon veil, etc.

The surfacing film may be combined with an electrically conductive layer to impart lighting strike protection (LSP). The conductive layer may be selected from various expanded metal screens or foils for use as surfacing and lighting strike protection of aircraft composite parts. The metallic screens or foils may include expanded metallic screens or foils and metal coated veils.

The curable composition for forming the HT surfacing film may be applied to one or both surfaces of the conductive layer to form a bi-layer or a tri-layer structure, respectively, using conventional coating techniques. Alternatively, a pre-fabricated surfacing film is laminated to one side of a conductive layer to form a bi-layer structure, or two pre-fabricated surfacing films are laminated onto opposite surfaces of the conductive layer to form a tri-layer structure. The conductive layer may also be embedded into the surfacing film.

The HT surfacing film disclosed herein can be co-cured with a fiber-reinforced, BMI-based composite substrate at a temperature in the range of 300° F.-380° F. (or 148° C.-193° C.). For BMI-based composite substrates, a post cure is required to impart the high temperature properties. This post cure may occur at a temperature range of greater than 350° F. (176.66° C.) and up to 510° F. (265° C.).

The fiber-reinforced, BMI-based composite substrate is composed of reinforcement fibers impregnated with or embedded in a matrix resin. The matrix resin includes one or more BMI resin(s), and optionally, epoxy resin(s). The composite substrate may be in the form of a prepreg ply or a prepreg layup. The prepreg ply is composed of reinforcement fibers in the form of a fabric or directionally aligned, continuous fibers that have been impregnated with a resin. The directionally aligned fibers may be unidirectional or multi-directional fibers. The prepreg layup is composed of a plurality of prepreg plies arranged in a stacking sequence.

In general, the uncured HT surfacing film may be applied onto a fiber-reinforced composite substrate, which is in an uncured or partially cured state, followed by co-curing to form a fully-cured composite structure bonded to a thermoset (hardened) surfacing film. After curing, the surfacing film is the outermost layer of the composite structure.

The resulting surfacing film is highly cross-linked with a high T_{g} as discussed above. The cured surfacing film provides a paint-ready surface free of surface imperfections such as pinholes, pits or porosity. If the surfacing film is additionally combined with a metallic screen, foil or metal coated veil, the surface will also have adequate lightning strike protection properties.

The HT surfacing film of the present disclosure has a higher glass transition temperature (T_{g}) as compared to that of the current epoxy-based surfacing films on the market today. T_{g} of greater than 215° C. (e.g., up to 300° C.) is achievable, depending on which BMI co-monomer is utilized, as compared to the T_{g} of approximately 180° C. of existing epoxy-based surfacing films.

The thermal stability of the cured HT surfacing film as measured by Thermogravimetric Analysis (TGA) has been found to be 330° C.-390° C. as defined by the temperature at 5% weight loss. In contrast, the thermal stability of the current epoxy-based surfacing films on the market is about 270° C.-285° C. as defined by the temperature at 5% weight loss.

### EXAMPLES

The following examples serve to give specific embodiments of the HT surfacing films formed according to the present disclosure but are not meant in any way to limit the scope of the present disclosure.

### Example 1

A curable resin composition for forming an HT surfacing film was prepared based on the formulation shown in Table 1. The amounts shown in Table 1 are in weight percentage (wt %) based on the total weight of the entire composition. Table 1A shows the components for forming the pre-react adduct in Table 1. The components shown in Table 1A are pre-reacted to form the pre-react adduct prior to being incorporated into the curable resin composition of Table 1. The amounts in Table 1A are indicated in weight percentage (wt %) based on the total weight of all components for the adduct.

In Table 1, BMI-H refers to N,N′-(4,4′-diphenylmethane)bismaleimide.

TABLE 1

| Components | wt % |
|---|---|
| Pre-react Adduct (Table 1A) | 13 |
| Diallyl (Matrimid 5292 B) | 25 |
| BMI-H | 32 |
| Zeeospheres G200 | 18 |
| TiO2 | 9 |
| Carbon Black | 1 |
| Fumed silica (Cabosil TS 720) | 2 |
| Total | 100 |

TABLE 1A
Pre-React Adduct

| Components | wt % |
|---|---|
| Accelerator (Triphenyl Phosphine) | 0.23 |
| Diglycidyl Ether of Bisphenol A (DER 331) | 54.6 |
| Tactix 556 | 27.7 |
| Nitrile Rubber Elastomer (Nipol 1072) | 5.93 |
| CTB | 11.54 |
| Total | 100 |

The pre-react adduct was prepared by mixing the components in Table 1A and heating the mixture to 300° F. (or 148.9° C.) for one hour.

The resin composition was prepared by adding the components disclosed in Table 1 into a mixing vessel and mixing the components using a high shear lab mixer. BMI-H resin and diallyl co-monomer were added first. MEK was added as a solvent to the BMI resin and co-monomer mixture to adjust the rheology and solid content of the mixture. Subsequently, the pre-react adduct was added to the mixing vessel. Zeeospheres, fumed silica and carbon black were further added to the mixer. Additional MEK solvent was added to control the viscosity of the composition to about 90 wt % solids. The components of the composition were mixed for 50 minutes at 2000 rpm. The temperature of the composition during mixing was kept at 75° F. (23° C.). Additional MEK was added to achieve 90 wt % solids.

To form a surfacing film, the prepared resin composition was strained, de-aired, and deposited as a resin film. Straining was performed through a nylon mesh. De-airing was performed such that the solid content of the composition was about 90 wt %. The strained and de-aired composition was then coated as a film having a film weight of 0.020 psf (or 97.6 gsm) on a film coater and then dried so as to achieve a film with volatiles content of less than 1%.

### Example 2

A curable resin composition for forming an HT surfacing film was prepared based on the formulation shown in Table 2. The formulation for the pre-react adduct is disclosed in Table 2A. The amounts in the Tables are indicated in weight percentage (wt %).

TABLE 2

| Components | wt % |
|---|---|
| Pre-react Adduct (Table 2A) | 14.8 |
| Bisallyl Ether (TM 124-Ether) | 34 |
| 2,2-bis[4-(4-maleimidophenoxy)phenyl)]propane (BMPP) | 29.2 |
| Zeeospheres G210 | 16 |
| TIO2 | 3 |
| Fumed silica (Cabosil TS 720) | 3 |
| Total | 100 |

TABLE 2A
Pre-react Adduct

| Components | wt % |
|---|---|
| Accelerator (Triphenyl Phosphine) | 0.2 |
| Diglycidyl Ether of Bisphenol A (EPON 828) | 37.2 |
| Tactix 756 | 43.9 |
| Nitrile Rubber Elastomer (Nipol 1472) | 11.3 |
| CTBN | 7.4 |
| Total | 100 |

The pre-react adduct was prepared by mixing the components in Table 2A and heating the mixture to 300° F. (or 148.9° C.) for one hour.

The resin composition was prepared by adding the components disclosed in Table 2 into a mixing vessel and mixing the components using a high shear lab mixer. The mixing conditions were as described in Example 1. The resulting resin composition after mixing had a solid content of 85 wt %. A resin film was formed from the resin composition by the film forming method described in Example 1. The dried resin film had a film weight of 0.045 psf (or 220 gsm).

### Example 3

A curable resin composition for forming an HT surfacing film was prepared based on the formulation shown in Table 3. The formulation for the pre-react adduct is disclosed in Table 3A. The amounts in the Tables are indicated in weight percentage (wt %).

TABLE 3

| Components | wt % |
|---|---|
| Pre-react Adduct (Table 2A) | 12.1 |
| Dipropenyl (TM 123) | 24.7 |
| MXBI | 24.7 |
| Zeeospheres W200 | 26 |
| TiO2 | 10 |
| Black Dye | 1 |
| Fumed silica (Cabosil TS 720) | 1.5 |
| Total | 100 |

TABLE 3A
Pre-React Adduct

| Components | wt % |
|---|---|
| Accelerator (Triphenyl Phosphine) | 0.25 |
| Diglycidyl Ether of Bisphenol A (DER 331) | 34.7 |
| Tactix 556 | 9.1 |
| Tactix 756 | 17.35 |
| Nitrile Rubber Elastomer (Nipol 1072) | 17.1 |
| CTB | 21.5 |
| Total | 100 |

The pre-react adduct was prepared by mixing the components in Table 3A and heating the mixture to 300° F. (or 148.9° C.) for one hour.

The resin composition was prepared by adding the components disclosed in Table 3 into a mixing vessel and mixing the components using a high shear lab mixer. The mixing conditions were as described in Example 1. The resulting resin composition after mixing had a solid content of 95 wt %. A resin film was formed from the resin composition by the film forming method described in Example 1. The dried resin film had a film weight of 0.015 psf (or 73 gsm).

### Example 4

A curable resin composition for forming an HT surfacing film was prepared based on the formulation shown in Table 4. The formulation for the pre-react adduct is disclosed in Table 4A. The amounts in the Tables are indicated in weight percentage (wt %).

TABLE 4

| Components | wt % |
|---|---|
| Pre-react Adduct (Table 2A) | 15.5 |
| Diamine (4,4- Diaminodiphenylsulfone (DDS) | 20 |
| HMDA BMI | 32 |
| Zeeospheres G200 | 20 |
| TiO2 | 8 |
| Carbon Black | 2 |
| Fumed silica (Cabosil TS 720) | 2.5 |
| Total | 100 |

TABLE 4A
Pre-React Adduct

| Components | wt % |
|---|---|
| Accelerator (Triphenyl Phosphine) | 0.19 |
| Diglycidyl Ether of Bisphenol A (EPON 828) | 39.3 |
| Tactix 556 | 13.51 |
| Tactix 756 | 7.1 |
| Nitrile Rubber Elastomer (Nipol 1472) | 20.5 |
| CTBN | 19.4 |
| Total | 100 |

The pre-react adduct was prepared by mixing the components in Table 4A and heating the mixture to 300° F. (or 148.9° C.) for one hour.

The resin composition was prepared by adding the components disclosed in Table 4 into a mixing vessel and mixing the components using a high shear lab mixer. The mixing conditions were as described in Example 1. The resulting resin composition after mixing had a solid content of 95 wt %. A resin film was formed from the resin composition by the film forming method described in Example 1. The dried resin film had a film weight of 0.030 psf (or 146 gsm).

### Example 5

A curable resin composition for forming an HT surfacing film was prepared based on the formulation shown in Table 5. The formulation for the pre-react adduct is disclosed in Table 5A. The amounts in the Tables are indicated in weight percentage (wt %).

TABLE 5

| Components | wt % |
|---|---|
| Pre-react adduct (Table 5A) | 13.3 |
| TM 123 | 20 |
| 2,2-bis[4-(4-maleimidophenoxy)phenyl)]propane (BMPP) | 32 |
| Zeeospheres G200 | 30 |
| TiO2 | 1.2 |
| Carbon Black | 2.5 |
| Fumed silica (Cabosil TS 720) | 1 |
| Total | 100 |

TABLE 5A
Pre-react Adduct

| Components | wt % |
|---|---|
| Nipol 1072 (Nitrile Rubber Elastomer) | 8.8 |
| Triphenyl Phosphine | 0.2 |
| Kaneka MX 120 Resin containing 25 wt % of CSR | 60.2 |
| Tactix 556 | 10.5 |
| Tactix 756 | 10.5 |
| CTBN | 9.8 |
| Total | 100 |

The pre-react adduct was prepared by mixing the components in Table 5A and heating the mixture to 300° F. (or 148.9° C.) for one hour.

The resin composition was prepared by adding the components disclosed in Table 5 into a mixing vessel and mixing the components using a high shear lab mixer. The mixing conditions were as described in Example 1. The resulting resin composition after mixing had a solid content of 90 wt %. A resin film was formed from the resin composition by the film forming method described in Example 1. The dried resin film had a film weight of 0.010 psf (or 49 gsm).

### Example 6

A curable resin composition for forming an HT surfacing film was prepared based on the formulation shown in Table 6. The formulation for the pre-react adduct is disclosed in Table 6A. The amounts in the Tables are indicated in weight percentage (wt %).

TABLE 6

| Components | wt % |
|---|---|
| Pre-react adduct (Table 6A) | 17 |
| Matrimid 5292 B (Hunstman) | 21.5 |
| BMI H | 31.5 |
| Zeeospheres G210 | 25 |
| Carbon Black | 2 |
| Fumed silica (Cabosil TS 720) | 3 |
| Total | 100 |

TABLE 6A

| Components | wt % |
|---|---|
| Nipol 1472 (Nitrile Rubber Elastomer) | 16.02 |
| Triphenyl Phosphine | 0.18 |
| Kaneka MX 257 Resin containing 37 wt % of CSR | 32.4 |
| MY0510 | 19.1 |
| Tactix 556 | 11.7 |
| CTBN | 20.6 |
| Total | 100 |

The pre-react adduct was prepared by mixing the components in Table 6A and heat the mixture to 300° F. (or 148.9° C.) for one hour.

The resin composition was prepared by adding the components disclosed in Table 6 into a mixing vessel and mixing the components using a high shear lab mixer. The mixing conditions were as described in Example 1. The resulting resin composition after mixing had a solid content of 90 wt %. A resin film was formed from the resin composition by the film forming method described in Example 1. The dried resin film had a film weight of 0.040 psf (or 195 gsm).

### Example 7

A curable resin composition for forming an HT surfacing film was prepared based on the formulation shown in Table 7. The formulation for the pre-react adduct is disclosed in Table 7A. The amounts in the Tables are indicated in weight percentage (wt %).

TABLE 7

| Components | wt % |
|---|---|
| Pre-react adduct (Table 7A) | 15 |
| TM 124-Ether (Bisphenol A bisallyl ether) | 22 |
| HMDA BMI | 31 |
| Zeeospheres G200, G210, W200 | 28 |
| TiO2 | 1 |
| Carbon Black or Black Dye | 1 |
| Flow Control Agents (Cabosil TS 720) | 2 |
| Total | 100 |

TABLE 7A

| Components | wt % |
|---|---|
| Nipol 1072 (Nitrile Rubber Elastomer) | 11.5 |
| Triphenyl Phosphine | 0.2 |
| Kaneka MX 156 containing 25 wt % of CSR | 16.7 |
| MY 721 | 43.3 |
| Tactix 756 | 13.3 |
| CTB | 15 |
| Total | 100 |

In Table 7, HMDA BMI refers to 1,6-hexamethylenediamine bismaleimide.

The pre-react adduct was prepared by mixing the components in Table 7A and heat the mixture to 300° F. (or 148.9° C.) for one hour.

The resin composition was prepared by adding the components disclosed in Table 7 into a mixing vessel and mixing the components using a high shear lab mixer. The mixing conditions were as described in Example 1. The resulting resin composition after mixing had a solid content of 85 wt %. A resin film was formed from the resin composition by the film forming method described in Example 1. The dried resin film had a film weight of 0.020 psf (or 98 gsm).

### Example 8

### Properties of Cured Surfacing Films

Each of the resin films prepared in Examples 1-7 was spread into a mold and cured using the following autoclave cure cycle: 3° F./min (about 2° C./min) ramp to 350° F. (176.7° C.); hold at 350° F. for 360 min; followed by post cure for 360 minutes at 440° F. (226.7° C.).

Thermomechanical Analysis (TMA) was used to determine the T_{g} of each cured resin sample using a TA Instruments TMA Q400 at a ramp rate of 10° C./min from room temperature to 350° C. Thermogravimetric Analysis (TGA) was performed using a TGA Q50 (TA Instruments) on each cured resin sample to determine thermal stability with a ramp of 10° C./min to 500° C. The thermal stability was defined as the 5% weight loss of the cured materials. The results of TMA and TGA are reported in Table 8.

TABLE 8

| | | TGA 5% Weight Loss |
|---|---|---|
| | T_{g} by TMA (° C.) | on cured sample(° C.) |
| Example 1 | 301.32 | 385.46 |
| Example 2 | 286.59 | 387.94 |
| Example 3 | 273.51 | 383.38 |
| Example 4 | 291.48 | 396.34 |
| Example 5 | 310.10 | 398.42 |
| Example 6 | 256.48 | 397.63 |
| Example 7 | 227.53 | 385.42 |

The results in Table 8 demonstrate the high temperature properties and stability of the cured BMI-based surfacing films. Such properties confirm that these BMI-based surfacing films are suitable for use at high temperatures (>180° C.) and in extreme environments. The cured resins of Examples 1-7 exhibit T_{g} values from 227.53° C. to 310.10° C., all which are well above the common T_{g} of conventional epoxy-based surfacing film materials. Such conventional epoxy-based surfacing film materials typically have a T_{g} of approximately 177° C. or lower. The T_{g} and thermal stability of the BMI-based surfacing films also demonstrate the ability of these films to be co-cured with BMI-based composites which can sometimes have post cure temperature of 275° C. or greater. The TGA, specifically the 5% weight loss of the cured materials, is also much higher than for conventional epoxy-based surfacing films, which typically occur between about 280° C. to about 290° C. Consequently, the BMI-based surfacing films of Examples 1-7 would be able to withstand more easily thermal excursions in higher temperature environments.

1. (canceled)

2. A surfacing film formed from a curable resin composition comprising:
a) at least one bismaleimide (BMI) monomer;
b) at least one co-monomer that is reactive with the BMI monomer; (iii)
c) a pre-react adduct;
d) inorganic microspheres, each having a hollow core; and
e) inorganic filler in the form of particles that are not microspheres;
wherein the pre-react adduct is a reaction product of, one or more multifunctional epoxy resins, epoxy dicyclopenta-diene (DCPD), and one or more elastomer(s), and optionally, core-shell rubber (CSR) particles.

3. The surfacing film according to claim 2, wherein the pre-react adduct is a reaction product of core-shell rubber (CSR) particles, a difunctional epoxy resin, dicyclopenta-diene (DCPD), an elastomer, and a tri-functional or tetra-functional epoxy resin.

4. The surfacing film according to claim 2, wherein the co-monomer is selected from allyl compounds, aromatic amines, and propenyl benzophenone.

5. The surfacing film according to claim 4, wherein the co-monomer is selected from: 2,2′-Diallyl Bisphenol A or o,o′-Diallyl Bisphenol A; Diallyl Ether of Bisphenol A; 2,2′-Diallyl-4,4′-biphenol; 3′-Allyl-4′hydroxyacetophenone; Diallyl Phthalate; Triallyl Isocyanurate; Triallyl Cyanurate; Triallyl Trimellitate; 4,4′-methylenedianiline (MDA); 4,4′-Diaminodiphenylsulfone (DDS); m- or p-phenylene diamine (PD); and 4,4′-bis(o-propenylphenoxy)benzophenone.

6. The surfacing film according to claim 3, wherein the difunctional epoxy resin is selected from: diglycidylether of Bisphenol A, diglycidylether of Bisphenol F, diglycidylether of Bisphenol S, diglycidylether of Bisphenol Z, diglycidylethers of tetrabromo bisphenol A, and the diepoxide of hydrogenated Bisphenol A, preferably, diglycidylether of Bisphenol A or F.

7. The surfacing film according to claim 3, wherein said tri-functional epoxy resin is triglycidyl ether of aminophenol.

8. The surfacing film according to claim 3, wherein said tetra-functional aromatic epoxy resin is tetraglycidyl ether of methylene dianiline.

9. The surfacing film according to claim 3, wherein the CSR particles for forming the pre-react adduct have particle size of 300 nm or less, as measured by a laser diffraction technique.

10. The surfacing film according to claim 2, wherein the one or more elastomer(s) for forming the pre-react adduct contains/contain carboxyl or amine functional groups.

11. The surfacing film according to claim 2, wherein the one or more elastomer(s) for forming the pre-react adduct is/are selected from: amine-terminated butadiene acrylonitrile (ATBN), carboxyl-terminated butadiene acrylonitrile (CTBN), carboxyl-terminated butadiene (CTB), fluorocarbon elastomers, silicone elastomers, and styrene-butadiene polymers.

12. The surfacing film according to claim 2, wherein the pre-react is formed by reacting the following components, in weight percentages (wt %):
1-5 wt % Carboxylated Nitrile elastomer;
1-5 wt % CTBN or CTB elastomer;
1-15 wt % Epoxy Dicyclopentadiene (DCPD);
5-15 wt % Diglycidyl Ether of Bisphenol A; and
1-2 wt %, Triphenyl Phosphine.

13. The surfacing film according to claim 2, wherein the pre-react is formed by reacting the following components, in weight percentages (wt %):
1-5 wt % Carboxylated Nitrile elastomer;
5-15 wt % liquid difunctional epoxy resin containing 25-40 wt % CSR particles;
1-15 wt % Epoxy Dicyclopentadiene (DCPD);
1-15 wt % tri-functional or tetra-functional epoxy resin; and
1-2 wt % Triphenyl Phosphine.

14. The surfacing film according to claim 2, wherein the combination of BMI monomer(s) and co-monomer(s) constitutes, in weight percentage, more than 45% of the total weight of the curable resin composition.

15. The surfacing film according to claim 2, wherein the amount of pre-react adduct in the curable composition is about 8% to about 30% by weight based on the total weight of the curable resin composition.

16. (canceled)

17. The surfacing film according to claim 2, wherein the inorganic microspheres are made of glass, silica, or ceramic.

18. (canceled)

19. The surfacing film according to claim 2, wherein the inorganic fillers are made of a material selected from talc, mica, calcium carbonate, alumina, and silica.

20. (canceled)

21. A composite structure comprising:
a composite substrate comprising reinforcement fibers impregnated with or embedded in a curable matrix resin; and
the surfacing film according to claim 2 in contact with an outer surface of the composite substrate,
wherein the curable matrix resin of the composite substrate comprises one or more bismaleimide (BMI) monomer(s).

22. A composite structure comprising:
the surfacing film according to claim 2 formed on a prepreg layup of multiple prepreg plies,
wherein each prepreg ply comprises reinforcement fibers impregnated with or embedded in a curable matrix resin, and said matrix resin comprises one or more bismaleimide (BMI) monomer(s).

23. A conductive surfacing material comprising a conductive layer laminated to one side of or embedded in the surfacing film according to claim 2.

24. A method for forming a composite structure comprising:
forming a prepreg layup of multiple prepreg plies, each prepreg ply comprising reinforcement fibers impregnated with or embedded in a curable matrix resin;
bringing the surfacing film according to claim 2 into contact with the prepreg layup;
co-curing the surfacing material and the prepreg layup so as to form a cured composite structure; and
removing the cured composite structure from the molding tool.

25. (canceled)
